(19) United States
(12) Patent Application Publication
(10) Pub. No.: US 2008/0064767 A1
(43) Pub. Date: Mar. 13, 2008

(54) High-concentration nanoscale silver colloidal solution and preparing process thereof

(75) Inventors: Kan-Sen Chou, Hsinchu (TW); Yu-chieh Lu, Hsinchu (TW)

Correspondence Address: BIRCH STEWART KOLASCH & BIRCH, PO BOX 747, FALLS CHURCH, VA, 22040-0747, US

(73) Assignee: National Tsing Hua University

(21) Appl. No.: 11/518,200

(22) Filed: Sep. 11, 2006

(51) Int. Cl. B01F 17/00

(52) U.S. Cl. 516/97

(57) ABSTRACT

The present invention relates to a high-concentration nanoscale silver colloidal solution and the preparing process thereof. The colloidal solution of the present invention comprises a high content of silver particles, i.e. approximately 1.5 wt %. The mean size of the nanoscale silver is less than 10 nm. In the preparing process, silver salt, ionic chelating agent, stabilizing agent, reducing agent, solvent and reaction accelerator are homogeneously mixed together. The increase of reaction temperature by external heat source accelerates completed reaction. By using the specified reaction accelerator and chelating agent and under the operating condition of the present invention, high-density silver colloidal solution is obtained while inhibiting particle aggregation. Therefore, the resulting nanoscale silver colloidal solution contains very small-sized particles and the stability thereof is satisfactory.

### FIELD OF THE INVENTION

The present invention relates to a high-concentration nanotechnology, and more particularly to a process for preparing high-concentration nanoscale silver particles and to the product manufactured by such a preparing process.

### BACKGROUND OF THE INVENTION

Generally, the melting point of a solid substance at the large-size scale is constant, but its melting point considerably drops down when this substance is at the nano-size scale. This behavior is possibly related to the fact that the nonomaterial has a larger ratio of surface atoms than the micromaterial. As the particle size is decreased, the ratio of high-activity surface atoms is increased and thus the melting point of the nonoscale material is considerably reduced.

For example, the normal melting temperature of silver is 960° C., but the melting temperature of the nonoscale silver particles possibly drops down to 100° C. or less. Under a low temperature environment, the thermal resistance of the nonoscale silver particle is very low and thus the thermal conductivity thereof is very excellent. Due to the low thermal resistance and the high thermal conductivity, nonoscale silver particles are suitable as low temperature thermally conductive material. Under this circumstance, instead of using high temperature resistant ceramic material, polymeric material can be used as the substrate in order to enhance flexibility of the component.

Furthermore, the conductive silver paste formulated with the nanoscale silver powder can largely reduce the use amount of silver power without impairing the electrical conductivity thereof. For example, if the formulation of the conductive silver paste and the nanoscale silver is used in a conductive coating material, the wire density is increased, the firing temperature is reduced, and the quality of the film layer and the yield are enhanced. Whereas, when applied in the conductive joint bonding technology, the formulation of the conductive silver paste and the nanoscale silver has some advantages such as a reduced welding temperature, an increased interface compatibility, material-saving and leadless working environment.

Unlike other metals, silver has a high antibacterial efficacy in resisting or inhibiting propagation of cellular organisms. Since the increasing use of germicides and antibiotics is likely to cause antimicrobial resistance or drug resistance, medical practitioners pay much attention to the silver ion again. It is demonstrated that the germicidal efficacy of the silver ion is more than one hundred times the germicidal efficacy of the general germicide. In addition, the use of the silver ion imparts no toxic effect to the humans and is capable of killing more than 600 species of pathogenic bacteria, so that the silver ion has become the best natural germicidal material at the moment.

After the nanoscale silver particles are exposed to the ambient air, a thin layer of silver oxide is formed on the surface thereof. If the silver oxide contacts the water vapor in the ambient air, a trace amount of silver ion would be released. Experiments demonstrated that the silver ion of a very low concentration could freely enter and destroy the cell membranes of the bacteria. In addition, the silver ion may quickly bind to the sulfhydryl group of the enzyme in the human body so as to effectively block the enzyme activity for biosynthesis. The nanoscale silver particles are more easily penetrated into the affected part of the patient to release silver ions. Since the body fluid is colloidal, the colloidal silver is more compatible with the human body and is considered as an excellent germicidal product.

Currently, the related technologies associated with the development of the colloidal nanoscale silver are focused on improvement of the particle size. Due to limitation of cost, these technologies fail to be mass-produced.

Moreover, some of the current processes for producing the colloidal nanoscale silver are not industrially feasible for mass-production because the processing equipment is not cost-effective or the related fabricating procedures are too complicated. Among the current processes for producing the colloidal nanoscale silver, the most effective method for mass production is a so-called chemical reduction method because a high yield of nanoscale silver particle is obtained without using complicated or expensive equipment. If the product purity is further improved, this method is very advantageous.

Nowadays, an improved chemical reduction method is used for mass-production of the nanoscale particle. According to the improved chemical reduction method, in addition to the precursor of the metallic ion and the reducing agent, the reaction solution further contains some additives for inhibiting particle aggregation, for example a surfactant, a dispersing agent or the like. The surfactant may be properly dispersed or adsorbed on the surface of the particle to form a protection layer so as to avoid particle aggregation resulted from motion collision.

In most production methods, the particle size can be controlled below 100 nm. For a purpose of controlling the particle size, low initial concentration of silver is usually employed but too low silver content is not suitable for mass production. In addition, in the presence of a strong reducing agent such as hydrazine or formaldehyde, it is not easy to control the particle size. A reduction of the reaction temperature may overcome this problem but the result is not satisfactory. For example, in a case that formaldehyde is used as the reducing agent, the reaction is quickly completed at the low temperature to result in the particle size of about 30 nm. Although the use of formaldehyde as the reducing agent results in the stable particles, it is still hard to break through the barrier of preparing finer particles. On the other hand, in the weak reducing agent system, the reaction rate is increased due to increase of the reaction temperature. It is possible to obtain small-sized particles in the reducing system of polyalcohol. Unfortunately, the reaction should be kept at 120° C. or higher for an extended time and thus the power consumption is considerable. In contrast, small-sized particles are obtainable at relatively lower temperature in the reducing system of glucose. Nevertheless, the above-described methods have a common disadvantage of the presence of a broader particle size distribution because these methods fail to avoid occurrence of the heterogeneous reaction.

### SUMMARY OF THE INVENTION

In views of the above-described disadvantages resulted from the prior art, the present invention provides an additive for preparing the nanoscale silver colloidal solution. This additive has the ability to accelerate reaction. In addition, since this additive may form a complex with the precursor to inhibit violent rate in the initial reaction stage, this additive is also referred as an ionic chelating agent. This additive may be previously homogeneously dispersed in the reaction solution and then start to liberate the substances capable of promoting the reaction. Accordingly, the additive of the present invention can be used as a reaction accelerator.

Another object of the present invention provides a formulation of a nanoscale silver colloidal solution and the process for producing the same. With the proviso that small-sized particles are maintained without aggregation during the preparation process, the reaction temperature is increased to accelerate the reaction so as to achieve high yield in a short time period. In accordance with the formulation and the operating condition provided by the present invention, the colloidal solution having high content of solid silver component may effect a complete reaction within one hour, thereby resulting in the particles having mean particle size of less than 10 nm. The resulting nanoscale silver paste maintains its stability for at least 180 days at room temperature (i.e. 20˜30° C.) without obvious aggregative precipitation. It is found that a reduced ambient temperature facilitates storing the products.

The object of the present invention is achieved by carrying out a reduction reaction of a specified reactant composition. The reactant composition of the present invention includes a silver salt (i.e. the precursor of the nanoscale silver particles), a stabilizing agent, a chelating agent, a reducing agent, deionized water and a reaction accelerator. For example, in a preferred embodiment of preparing a 1.5 wt % of nanoscale silver colloidal solution, the reactant composition comprises 1˜5 wt % of silver nitrate, 5˜20 wt % of stabilizing agent, 10˜20 wt % of chelating agent, 1˜5 wt % of reducing agent, 50˜80 wt % of deionized water and 0.1˜1 wt % of reaction accelerator.

Examples of the silver salts useful in the synthesis reaction include but are not limited to silver nitrate, silver sulfate, silver perchlorate and other silver-containing salt compound.

The stabilizing agent is also called as a surfactant including an anionic surfactant, a cationic surfactant, an amphoteric surfactant and a nonionic surfactant. There are two methods for controlling aggregation of particles. In accordance with the first method, by creating surface charges, the electrostatic repulsion associated with the net charge of the particles is increased due to adsorption onto the surfactant. The second method creates a barrier layer between the particles to increase their mobile difficulties. Most of the ionic surfactants are based on the former while the nonionic surfactants are based on the latter. Experimentally, the exemplary surfactants include sodium dodecyl sulphate (SDS), polyvinyl pyrrolidone (PVP), polyvinyl alcohol (PVA), etc. Most preferably, polyvinyl pyrrolidone (PVP) is used as the stabilizing agent of the present invention to provide the best effect on inhibiting particle size. In other words, this stabilizing agent imparts mobile barrier between the particles to increase their mobile difficulties, so that the aggregation actions are reduced. Moreover, depending on the molecular weight of polyvinyl pyrrolidone (PVP), the optimum concentration range is varied. In an embodiment of the present invention, the molecular weight of polyvinyl pyrrolidone (PVP) is approximately 40,000, and the operable concentration is preferably 5˜20 wt %, more preferably 10˜15 wt % with respect to the total weight of the solution.

The reducing agent is used to reduce ions contained in the metallic salt precursor into atomic state. The reducing agent is not specifically restricted as long as the oxidation-reduction potential of the overall reaction is positive. Exemplary reducing agents include sodium borohydride (NaBH₄), hydrazine (N₂H₄), formaldehyde (HCHO), glucose (C₆H₁₂O₆.H₂O), trisodium citrate (2Na.C₆H₅O₇.1H₂O), etc. In an embodiment, the reducing agent used in the present invention is glucose on account of its weak reducing power. By using glucose as the reducing agent, the violent reaction rate in the initial reaction stage is prevented and thus the problem of causing local aggregation of particles is overcome. Furthermore, the reaction rate can be adjusted by controlling the reaction temperature. Depending on the reaction rate, the resulting particle size is varied. By the way, due to the advantages such as non-toxicity and cost-effectiveness, glucose is the first candidate reducing agent in the present invention.

In the present invention, the reaction accelerator is employed to accelerate the reaction. According to the studies of the present inventors, the reducing agent has larger oxidation-reduction driving force in the basic environment. In other words, the addition of alkaline agent facilitates completed reaction in a short time period. The reaction accelerator is also referred as alkaline agent herein. The compound capable of generating hydroxide ions (OH) is useful as the reaction accelerator of the present invention. An exemplary reaction accelerator of the present invention is sodium hydroxide (NaOH).

The feature of present invention is selection of the chelating agent. The chelating agent is principally used to control the concentration of free metallic ions in the solution, so that the free metallic ions in the solution would undergo oxidation-reduction reaction with the reducing agent. According to Le Chatelier's principle, the consumption of the free ions will shift the equilibrium position toward generation of the free ions from dissociation of the chelating ions, thereby imparting good buffering effect. Due to some principles associated with the molecular adsorption behavior of the stabilizing agent, the aggregation behavior of resulting particles and the like, it is very critical to control the concentration of the metallic ions per unit volume. Experimentally and repeatedly, it is demonstrated that better particle size control of the particles resulted from reactive system is possible by using the chelating agent.

Particularly, the chelating agent used in the present invention is urea (CO(NH₂)₂) on account of easily availability and cost-effectiveness. Moreover, urea can provide the alkaline ions required for the succeeding reactions. The molecule of urea has a lone pair of electrons on the oxygen atom. Typically, four urea molecules chelate one silver ion to form a stable complex. Urea is very stable at room temperature but subject to decomposition at the temperature greater than about 80° C. The amino group via bond cleavage will be reacted with water molecules to generate alkaline ions. As known, the concentration of the alkaline ions is a key factor for influencing the particle size and controlling the conversion. The chelating agent useful in the present invention is not limited to urea. Actually, the compounds capable of homogeneously providing the alkaline ions required for reaction and having the protective ability to chelate precursor ions are also feasible as the chelating agent.

The preparing method of the nanoscale silver colloidal solution provided by the present invention has following advantages:

1. A high conversion is obtainable at high pH, but the reaction rate will be decreased as the reaction proceeds to gradually consume alkaline ions.

2. The conversion and the added amount of the alkaline agent are in direct proportion in the initial stage. In other words, the increase of the added amount of the initial alkaline agent may accelerate the reaction rate and reduce the complete reaction time.

3. The conversion is increased as the added amount of the initial alkaline agent is increased. The alkaline ions are instantly consumed at the moment of addition, and the pH values are continuously decreased. Continuous provision of alkaline agents is a desirable way for achieving high conversion. Nevertheless, heterogeneous provision of alkaline agents may result in too high density of precipitation particles and thus the relative amount of local stabilizing agent is insufficient. Under this circumstance, insufficient steric hindrance is likely to cause aggregation of large-size particles.

Since the thermal decomposition of urea continuously generates alkaline ions, the reaction is accelerated and continuously proceeds to achieve high conversion. In addition, due to continuous generation of new nucleation sites-alkaline ions at high pH, particle growth is not restricted to grow on the primary particles and the particle size would be effectively controlled.

In the currently known aqueous phase processes, it seems impossible to comply with both requirements of high conversion and small particle size. According to the present invention, the use of urea as the chelating agent appropriately makes up the deficiencies of the conventional processes. That is to say, urea has both functions of chelating metallic ions and homogeneously offering alkaline ions. Such dual roles of urea provide the present preparing method of small-sized nanoscale silver paste in high conversion.

According to the core technology of the present invention, urea is used as both chelating agent and reaction accelerator. In the initial stage, controlling the concentration of the silver ions participating in the reaction facilitates homogeneous dispersion of urea. In the middle and later stages, urea releases alkaline ions to provide energy for successive nucleation. These two capabilities are key factors for preparing small-sized nanoscale silver paste. In an embodiment of the present invention, the particle size of the nanoscale silver paste is successfully controlled at 8.5±2.5 nm even if the content of silver herein is up to 1.5 wt %. In addition, it is demonstrated that the nanoscale silver paste is very stable upon storage at room temperature.

The present invention is directed to an improvement of the aqueous chemical reduction method. With the proviso that small-sized particles are achieved in high conversion, the content of silver ions per unit volume is increased and thus the cost associated with preparing time and equipment is largely reduced. Nevertheless, small-sized silver particles are still maintained and the characteristics of nanomaterial are enhanced.

The technical contents of the present invention will now be described in more detail hereinafter with reference to the accompanying drawings that show various embodiments of the invention.

### BRIEF DESCRIPTION OF THE DRAWINGS

FIG. 1 is a flowchart of a process for preparing a nanoscale silver colloidal solution according to the present invention;

FIG. 2 is a plot showing the conversion of reaction under three different preparing conditions;

FIG. 3 is a plot showing the particle size distribution of nanoscale silver measured by dynamic light scattering equipment and obtained from a reaction for one hour under the reaction conditions of the present invention;

FIG. 4 is a TEM image of a nanoscale silver paste obtained under urea system according to the present invention and subject to a specified purification procedure followed by dilution; and

FIG. 5 is a TEM image of a nanoscale silver paste obtained under non-urea system according to prior art and subject to a specified purification procedure followed by dilution.

### DETAILED DESCRIPTION OF THE PREFERRED EMBODIMENTS

The technical contents of the present invention will now be described in more detail hereinafter with reference to the accompanying drawings that show various embodiments of the invention.

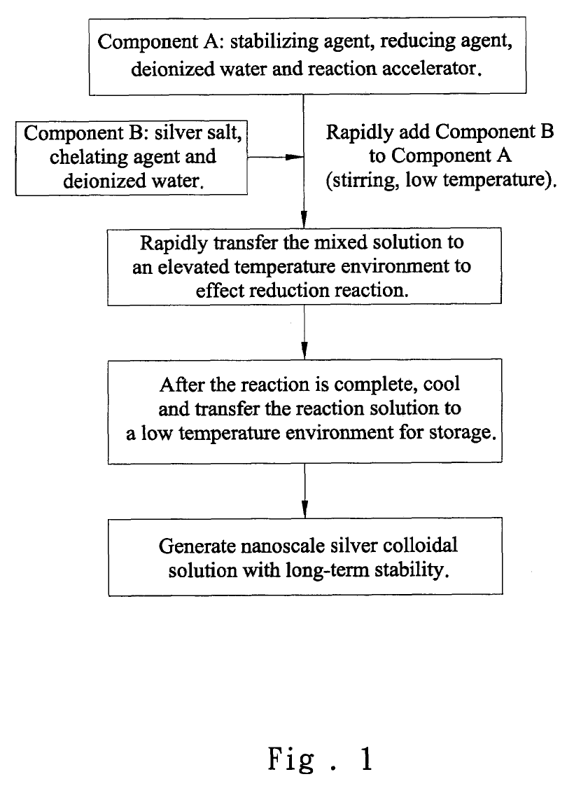

Referring to FIG. 1, a flowchart of a synthetic process according to a preferred embodiment of the present invention is illustrated. The reaction solution used in the present invention principally comprises two components, i.e. Component A and Component B. Component A includes stabilizing agent, reducing agent, reaction accelerator and deionized water. Component B includes metallic salt, ionic chelating agent and deionized water. With stirring and under the low temperature environment below 25° C., Component B is rapidly added to Component A. Then, the mixed solution of Component A and Component B is transferred to the elevated temperature environment of 80˜85° C. as soon as possible to perform a chemical reduction reaction. With continuous stirring, the reaction temperatures inside and outside the reactor are substantially identical. After the reaction is nearly complete, the reaction solution would be transferred to a low temperature environment for storage. It is demonstrated that this method is advantageous for stably maintaining the particle size.

### EXAMPLE 1

### Preparation of a Nanoscale Silver Colloidal Solution of the Present Invention

The nanoscale silver colloidal solution of the present invention is prepared according to the following steps:

1. 136 g of PVP (MW=40,000) is weighed and dissolved in deionized water (400 ml).

2. 17 g of silver nitrate is weighed and dissolved in deionized water (200 ml).

3. 1.6 g of sodium hydroxide is dissolved in the aqueous solution of PVP (prepared in the step 1).

4. 80 g of urea is dissolved in the aqueous solution of silver nitrate prepared in the step 2.

5. 36 g of glucose is dissolved in the aqueous solution of PVP (prepared in the step 1).

6. With stirring and at room temperature, the aqueous solution of silver nitrate (prepared in the step 2) is rapidly added to the aqueous solution of PVP (prepared in the step 1). The mixed solution is then transferred to a thermostatic bath at 85° C. and reacted for one hour. After the reaction mixture is cooled, the nanoscale silver colloidal solution of the present invention is obtained.

### EXAMPLE 2

### Effect of Composition Variations on the Results of the Present Invention

### I. Objective:

For a purpose of realizing the influences of composition variations on the results of the present invention, the amount of composition used in this example is varied hereinafter. For example, the added amount of sodium hydroxide or urea is adjusted to carry out the reaction. The particle size of resulting nanosalce silver particle and the conversion are examined in order to study the optimized condition of the present preparing method.

### II. Means:

The added amount of sodium hydroxide or urea is changed and the preparing steps of the present invention are repeatedly done. After the reaction proceeds for one hour, a trace amount of product is diluted to investigate the particle size distribution using dynamic light scattering (DLS) analysis. Furthermore, the concentration of the residual silver ions of the nanoscale silver paste is measured by using silver ion electrode so as to deduce the conversion of reaction. The reaction conditions used in this example include the conditions 2 and 3 shown in the following table.

| Condition 1 | Condition 2 | Condition 3 |
|---|---|---|
| Formulation | The same as that used in | The same as that used in |
| of example 1 | example 1 except for half | example 1 except for half |
| | amount of urea | amount of sodium hydroxide |

### III. Result:

In a case that the added amount of urea is double or half, the resulting particle size is substantially identical to that obtained in the example 1. In example 1, the concentration of urea in the solution is 13 times the quantity of silver nitrate. In principle, four urea molecules may chelate one silver ion to form a stable complex. Therefore, even half amount of urea is satisfied. As the ionic chelating agent, there is a lower limit of use amount thereof. It is recommended that the quantity of urea used in this example is at least four times the concentration of silver nitrate. The conversion, even though the use amount is reduced by 50%, still reaches above 95%. It is noted that more urea would result in higher conversion in the short time period.

Moreover, there are two sources of alkaline ions in the solution, i.e. sodium hydroxide and urea. In a case that the use quantity of urea is constant, half amount of sodium hydroxide may result in reduced conversion in principle. Accordingly, in the preparing processes using reduced amount of sodium hydroxide, the resulting particle size is substantially kept unchanged but the conversion is reduced.

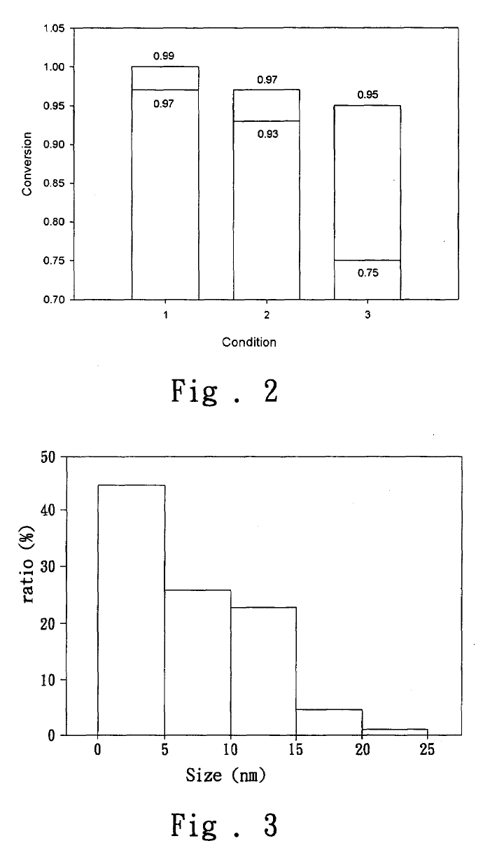

FIG. 2 is a plot showing the conversion of reaction on three different preparing conditions. The upper blocks and the lower blocks shown in FIG. 2 indicate the conversions obtained when the reaction proceeds for one hour and 30 minutes, respectively.

### IV. Conclusion:

In a case that a long reaction time is desired, the amount variation of sodium hydroxide has a larger influence on the convention of reaction than that of urea. In the present invention, the major role of urea is to provide chelating protection in the initial stage and facilitate occurrence of nucleation in the middle and later stages. Both capabilities allow for easy control of the particle size.

It is concluded that the provision of sodium hydroxide is responsible for the greatest part of the conversion. Moreover, the key factor for controlling particle size is the relative amount between sodium hydroxide and urea. For achieving the optimized conditions, the concentration ratio of NaOH/AgNO₃ is less than or equal to 0.4 and the concentration ratio of CO(NH₂)₂/AgNO₃ is greater than or equal to 4.

For preparing a 1.5 wt % of nanoscale silver colloidal solution, the most preferred operating condition uses a reactant composition including 1˜5 wt % of silver nitrate, 5˜20 wt % of stabilizing agent, 10˜20 wt % of chelating agent, 1˜5 wt % of reducing agent, 50˜80 wt % of deionized water and 0.1˜1 wt % of reaction accelerator.

In an exemplary operating condition, the ratio of PVP(MW=40,000) to AgNO₃ is 8/1 (gig), the reaction temperature is 85° C., the concentration of AgNO₃ solution is 0.167 M, the concentration of glucose solution is 0.334 M, the concentration of NaOH solution is 0.067 M, and the concentration of urea solution is 2.22 M. It is noted that this exemplary operating condition is one of the candidate operating conditions used in the present invention. The initial concentrations of the respective agents are described by reference. As the content of silver to be prepared is varied, numerous modifications and alterations of the operating conditions may be made while retaining the teachings of the invention.

The mean particle size of less than 10 nm is obtained without difficulties if the reaction of the present composition is carried out under the above described operation conditions. From the particle size distribution measured by dynamic light scattering (DLS) equipment, as shown in FIG. 3, arithmetical mean and standard deviation of the particles would be calculated. The result shows that the particle size of the nanoscale silver paste is 8.5±2.5 nm.

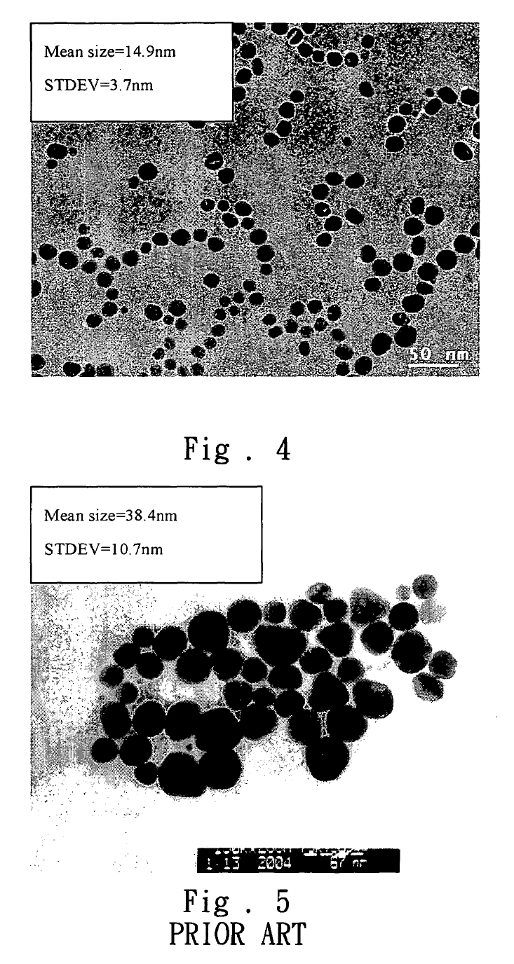

The nanoscale silver paste of the present invention comprises about 14 wt % of stabilizing agent and thus can be further diluted or concentrated depending on the succeeding applications. FIGS. 4 and 5 are transmission electron microscope (TEM) images of the nanoscale silver subject to a specified purification procedure followed by dilution. Although the nanoscale silver is possibly suffered from slight aggregation during dilution, the mean particle size is still controlled below 15 nm, as can be seen in FIG. 4. In contrast, the nanoscale silver obtained from the conventional non-urea system has larger particle size and broader particle size distribution (as shown in FIG. 5).

Since the nanoscale silver paste of the present invention comprises about 14 wt % of stabilizing agent, the nanoscale silver paste is very stable at low temperature. Even though most of the stabilizing agent is removed after purification and concentration, the content of silver in the solution reaches up to 20% by weight. In addition, the trace amount of stabilizing agent adsorbed on the particle surface may facilitate stabilizing the particles for several months.

According to the investigation on the further applications, low-concentration nanoscale silver solution has germicidal efficacy. After dilution, the nanoscale silver can be directly incorporated into some materials such as the clothing fibers, plastic material and the like to serve as the antibacterial agent. Furthermore, the nanoscale silver can be incorporated into organic paint via phase inversion. In addition to the germicidal efficacy, highly purified nanoscale silver paste exhibits excellent conductivity to be industrially used for IC wire printing, conductive ink-jet printing or electrical conduction or used as thermal adhesive.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A nanoscale silver composition comprising nanoscale silver particles having a mean particle size of less than 10 nm, wherein said mean particle size of said nanoscale silver particle maintains 20 nm or less for at least 180 days at room temperature.

2. The nanoscale silver composition of claim 1, comprising at least 5% w/w of stabilizing agent.

3. The nanoscale silver composition of claim 2, wherein said stabilizing agent is selected from a group consisting of sodium dodecyl sulphate (SDS), polyvinyl pyrrolidone (PVP) and polyvinyl alcohol (PVA).

4. The nanoscale silver composition of claim 1, comprising 1˜5% w/w of metallic silver.

5. A preparing process of a nanoscale silver composition, comprising steps of:
a) adding a stabilizing agent, a reducing agent and a reaction accelerator into deionized water to form an aqueous solution;
b) dissolving a chelating agent in an aqueous solution of silver salt and deionized water to form a stable complex;
c) rapidly adding the aqueous solution obtained in step b) to the aqueous solution obtained in step a) with stirring and at a low temperature environment below 25° C.; and
d) rapidly transferring the mixed solution to an elevated temperature environment of 80˜85° C. and effecting a reaction, thereby producing nanoscale silver particles having a mean particle size of less than 10 nm, wherein said particle size of said nanoscale silver particle maintains 20 nm or less for at least 180 days at room temperature.

6. The preparing process of claim 5, wherein said stabilizing agent is selected from a group consisting of sodium dodecyl sulphate (SDS), polyvinyl pyrrolidone (PVP) and polyvinyl alcohol (PVA).

7. The preparing process of claim 5, wherein said stabilizing agent is used in an amount of 5˜20% w/w.

8. The preparing process of claim 5, wherein said reducing agent is selected from a group consisting of sodium borohydride (NaBH₄), hydrazine (N₂H₄), formaldehyde (HCHO), glucose (C₆H₁₂O₆.H₂O) and trisodium citrate (2Na₃C₆H₅O₇.11H₂O).

9. The preparing process of claim 5, wherein said reducing agent is used in an amount of 1˜5% w/w.

10. The preparing process of claim 5, wherein said reaction accelerator is a alkaline agent capable of generating hydroxide ions (OH) in water.

11. The preparing process of claim 5, wherein said reaction accelerator is used in an amount of 0.1˜1% w/w.

12. The preparing process of claim 5, wherein said chelating agent is urea.

13. The preparing process of claim 5, wherein said chelating agent is used in an amount of 10˜20% w/w.

14. The preparing process of claim 5, wherein said silver salt is selected from a group consisting of silver nitrate, barium sulfate and silver perchlorate.

15. The preparing process of claim 5, wherein said reaction is effected at said elevated temperature environment of 80˜85° C. for 0.1˜1 hour.

16. The preparing process of claim 5, wherein the concentration ratio of said reducing agent to said silver salt is ranged from 1:2.5 to 1:10.

17. The preparing process of claim 5, wherein the concentration ratio of said chelating agent to said silver salt is ranged from 4:1 to 10:1.
